(19) United States
(12) Patent Application Publication
(10) Pub. No.: US 2012/0305731 A1
(43) Pub. Date: Dec. 6, 2012

(54) FIXTURE HOIST AND RETRACTABLE CEILING FIXTURE INCORPORATING THE SAME

(76) Inventor: Kyle M. Yearsley, Eagle, ID (US)

(21) Appl. No.: 13/149,478

(22) Filed: May 31, 2011

(51) Int. Cl. B66D 1/60; F21V 21/38

(52) U.S. Cl. 248/329

(57) ABSTRACT

A fixture hoist comprising a base assembly and a shuttle assembly. The base assembly is attachable to an overhead structure and includes a base with a motor disposed thereon. The motor includes a shaft rotatable in first and second directions and at least one drum coupled to the shaft. A cable is disposed about the drum, whereby the cable is selectively extended or retracted by rotating the shaft in one of the first and second directions. The base assembly includes at least one first datum fitting disposed on the base. The shuttle assembly is capable of supporting a fixture and is movable between a docked state and a deployed state. The shuttle assembly includes at least one second datum fitting configured to mate with the first datum fitting when the shuttle assembly is in the docked state.

### BACKGROUND

Whether in a residential or commercial setting, a high ceiling makes it very difficult to clean and/or maintain fixtures attached thereto, such as ceiling fans and chandeliers. As a result many people are resigned to tolerate an accumulation of spider webs, dust, and burnt out light bulbs on these inaccessible fixtures. If the ceiling is 9 feet tall or 100 feet tall, the problem is the same: poor access to out-of-reach fixtures means that there is no practical way for just one individual to quickly and easily clean, maintain or replace out-of-reach fixtures. Instead, out-of-reach fixtures are ignored, at least until the accumulation of filth and required maintenance motivates an individual to select one of two options: (a) risk bodily harm by ascending a tall ladder, or (b) spend hundreds of dollars to hire a professional scaffolding or cleaning service, in either case, to perform what should be routine maintenance and repair. Neither option is ideal because both depend on a person leaving the ground and ascending to the fixture to address any issues. Accordingly, there is a need for a convenient way to provide access to out of reach fixtures without leaving the ground.

### SUMMARY

Described herein are various exemplary embodiments of a fixture hoist and retractable ceiling fixture incorporating the same. A fixture can be mounted to the underside of the fixture hoist, so that when the hoist is activated, its dual cable system will lower the fixture, without twisting. The fixture hoist is designed to function on horizontal and sloped ceilings. When the hoist's cables pull the fixture back to the ceiling, datum features, or fittings, guide the final several inches of the fixtures assent, such that a solenoid locking mechanism is triggered and the fixture is secured to the ceiling.

The fixture hoist may mount to the ceiling in the same manner that the existing fixture would have previously mounted to the ceiling if the fixture hoist were not present. The fixture is then attached to the underside of the fixture hoist in the same manner that the fixture would have previously mounted to the ceiling (for example, the same sort of ceiling bracket previously used to mount the fixture to the ceiling would be integrated into the underside of the fixture hoist so that attaching the fixture to the fixture hoist is as easy as it previously was to attach the fixture to the ceiling). The electrical wiring from the ceiling and the fixture meet at a contact point within the fixture hoist so that power is shut off upon lowering the fixture, and power is restored when the fixture is locked back in place.

In one exemplary embodiment, a fixture hoist comprises a base assembly and a shuttle assembly. The base assembly is attachable to an overhead structure and includes a base with a motor disposed thereon. The motor includes a shaft rotatable in first and second directions and at least one drum coupled to the shaft. A cable is disposed about the drum, whereby the cable is selectively extended or retracted by rotating the shaft in one of the first and second directions. The base assembly also includes at least one first datum fitting disposed on the base. The shuttle assembly is capable of supporting a fixture and is movable between a docked state and a deployed state. The shuttle assembly includes a shuttle chassis attached to the cable, whereby the shuttle assembly is deployed by extending the cable and docked by retracting the cable. The shuttle assembly includes at least one second datum fitting configured to mate with the first datum fitting when the shuttle assembly is in the docked state.

In other embodiments, the fixture hoist may comprise a pair of first datum fittings and a pair of second datum fittings. The first datum fitting may comprise a socket and the second datum fitting may comprise a pin. The socket may comprise a frustoconical receptacle or a portion of a frustoconical receptacle. The base assembly may include a pair of drums coupled to the shaft with a cable disposed about each of the drums. A clutch may be coupled between the shaft and the drum. The fixture hoist may further comprise a locking mechanism operative to secure the shuttle assembly to the base assembly when the shuttle assembly is docked. The hoist may also include a switch operative to activate the locking mechanism when the shuttle assembly is in the docked state. A plurality of cooperative electrical contacts may be disposed on the base and the shuttle chassis that are operative to transmit electricity to a fixture supported by the shuttle assembly.

In another exemplary embodiment, a ceiling fixture hoist comprises a base assembly attachable to a ceiling, a shuttle assembly capable of supporting a ceiling fixture, and a locking mechanism operative to secure the shuttle assembly to the base assembly. The base assembly includes a motor disposed on a base. In this embodiment, the motor includes a double ended shaft rotatable in first and second directions and a clutch coupled to each end of the double ended shaft. A drum is coupled to each clutch and has a cable disposed about it, whereby the cables are selectively extended or retracted by rotating the shaft. The base assembly also includes a pair of datum sockets. The shuttle assembly includes a shuttle chassis attached to the cables, whereby the shuttle assembly is deployed by extending the cables and docked with the base assembly by retracting the cables. The shuttle assembly also includes a pair of datum pins that are configured to mate with the datum sockets when the shuttle assembly meets the base assembly in the docked state.

In a further exemplary embodiment, a retractable ceiling fixture comprises a base assembly attachable to a ceiling and a ceiling fixture assembly movable between a docked state and a deployed state. The base assembly includes a base with a motor disposed thereon. The motor includes a shaft with at least one clutch coupled to the shaft and at least one drum coupled to the clutch. A cable is disposed about the drum, whereby the cable is selectively extended or retracted by rotating the shaft in one of first and second directions. The base assembly also includes at least one first datum fitting disposed on the base. The ceiling fixture assembly includes a ceiling fixture, such as for example a chandelier or ceiling fan, attached to the cable. The ceiling fixture assembly is deployed by extending the cable and docked with the base assembly by retracting the cable. The ceiling fixture assembly includes at least one second datum fitting configured to mate with the first datum fitting when the ceiling fixture assembly is in the docked state. The retractable ceiling fixture may also include a locking mechanism operative to secure the ceiling fixture assembly to the base assembly. The retractable ceiling fixture may also include a pair of first datum fittings and a pair of second datum fittings, wherein the first datum fittings are sockets and the second datum fittings are pins.

The foregoing and other features, utilities, and advantages of the fixture hoist will be apparent from the following more particular description of the exemplary embodiments as illustrated in the accompanying drawings.

### BRIEF DESCRIPTION OF THE DRAWINGS

The accompanying drawings, which are incorporated in and constitute a part of this specification, illustrate embodiments of a fixture hoist and together with the description, serve to explain the principles and operation thereof. Like items in the drawings are generally referred to using the same numerical reference.

FIG. 1 illustrates a fixture attached to an overhead structure;

FIG. 2 illustrates a fixture attached to an overhead structure via a fixture hoist according to a first exemplary embodiment;

FIG. 3 is a partial cross-sectional view of the fixture hoist shown in FIG. 2;

FIG. 4 is a partial cross-sectional view of a fixture hoist according to a second exemplary embodiment;

FIG. 5 is a partial cross-sectional view of a fixture hoist according to a third exemplary embodiment shown in the docked state;

FIG. 6 is a partial cross-sectional view of the fixture hoist shown in FIG. 5 in a deployed state;

FIG. 7 is a top plan view of a base assembly for a fixture hoist according to a fourth exemplary embodiment;

FIG. 8 is a perspective view of the base assembly shown in FIG. 7;

FIG. 9 is a top plan view of a shuttle assembly for the fixture hoist according to the fourth exemplary embodiment;

FIG. 10 is a perspective view of the shuttle assembly shown in FIG. 9; and

FIG. 11 is a side view of the fixture hoist shown in FIGS. 7-10 attached to an angled support structure.

### DETAILED DESCRIPTION

Described herein is a fixture hoist for raising and lowering fixtures, such as ceiling fixtures, in a manner that provides convenient access for the cleaning and maintenance of the fixture. The disclosed fixture hoist raises and lowers ceiling fans, chandeliers and other fixtures for effortless access.

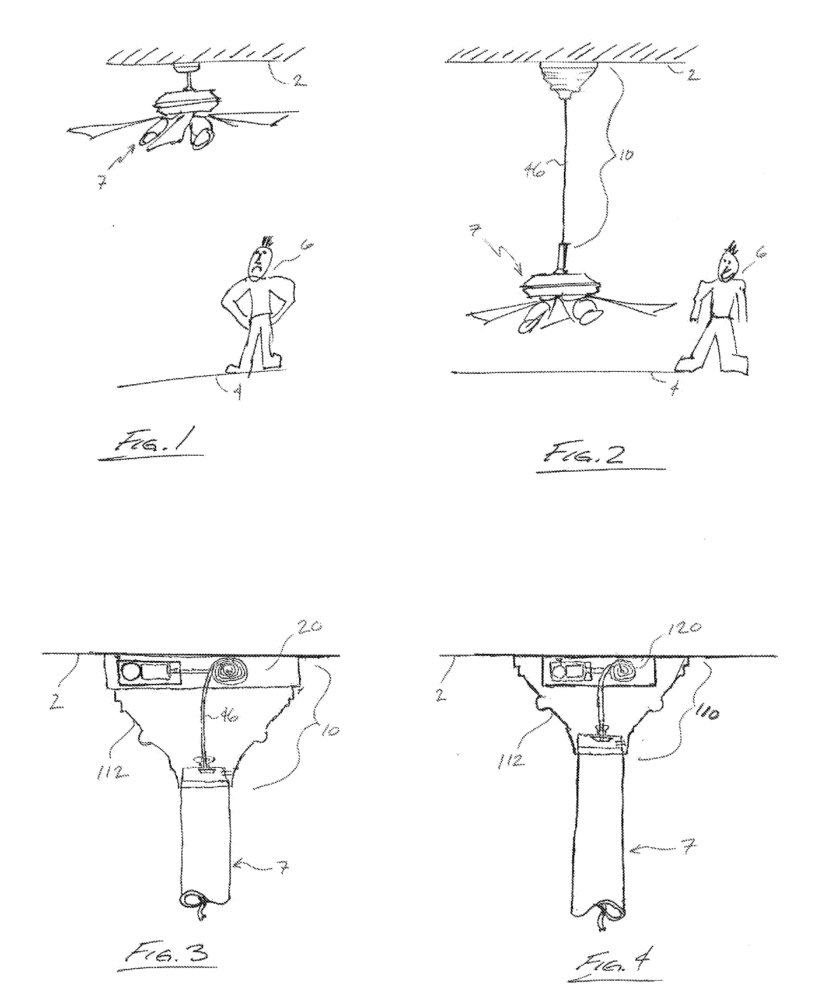

FIG. 1 illustrates fixture 7, in this case a ceiling fan, that is attached to an overhead structure 2 above ground level 4. In this case, the overhead structure is a ceiling and the fixture may be referred to as a ceiling fixture. Traditionally, ceiling fixtures are fixedly attached to the ceiling. Accordingly, when ceiling fixture 7 needs maintenance, cleaning, or a bulb replacement, a user 6 must climb on a ladder or hire a professional to maintain fixture 7.

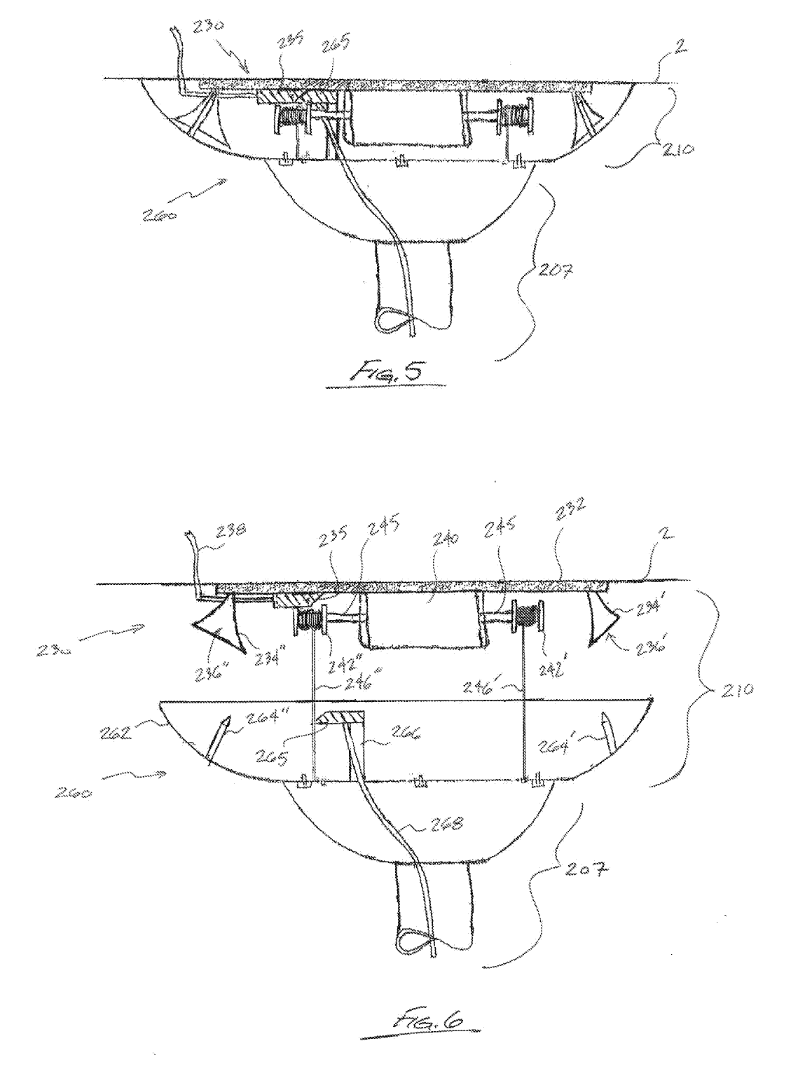

As shown in FIG. 2, a fixture hoist 10, according to a first exemplary embodiment, facilitates the maintenance of such ceiling fixtures by bringing them closer to ground level. In this case, fixture hoist 10 is attached to ceiling 2 and includes a selectively retractable or extendable cable 46. Fixture hoist 10 is operative to lower the fixture towards ground level 4 such that user 6 may maintain ceiling fixture 7. With reference to FIG. 3, fixture hoist 10 includes a base assembly 20 attached to ceiling 2. Base assembly 20 is operative to extend and retract cable 46 in order to lower and raise fixture 7. In this embodiment, fixture hoist 10 includes a decorative cover 112 that attaches on top of the base assembly 20. FIG. 4 represents a second exemplary embodiment, wherein fixture hoist 120 is contained within the decorative cover 112. In this embodiment decorative cover 112 may be attached to fixture 7 such that it travels with the fixture 7 as it is raised and lowered. Alternatively, decorative cover 112 may be attached to the ceiling such that the base assembly 120 remains covered when the fixture is lowered.

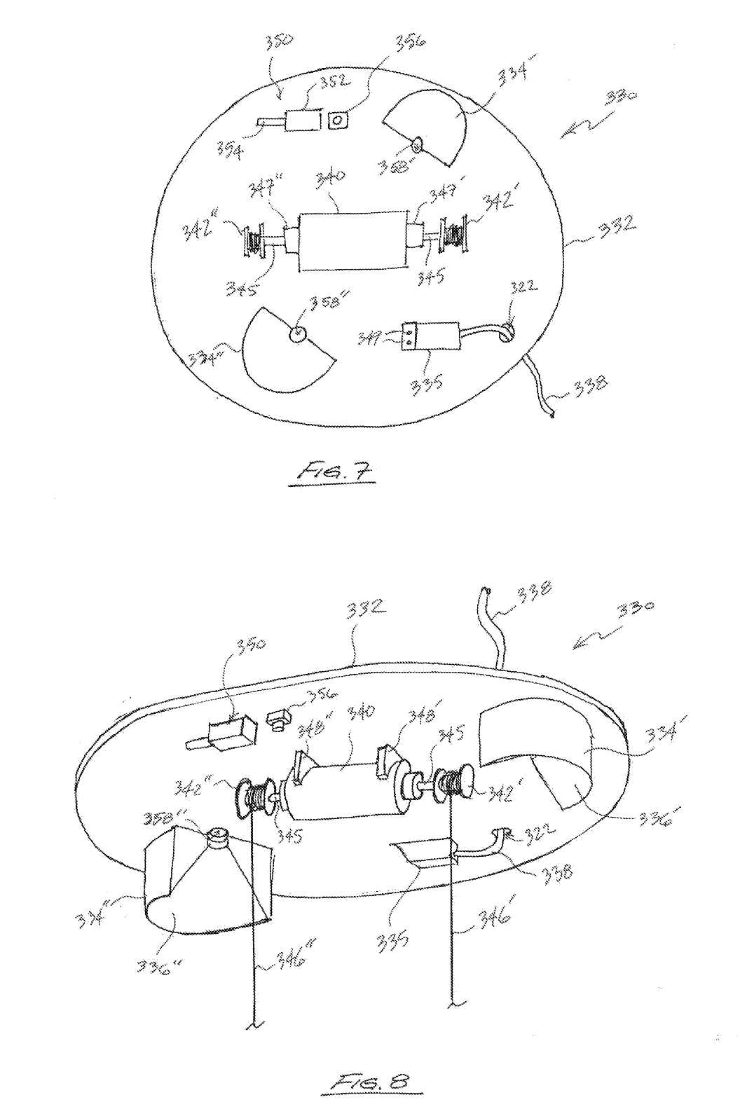

FIG. 5 illustrates a fixture hoist 210, according to a third exemplary embodiment, that includes a base assembly 230 attached to ceiling 2 and a shuttle assembly 260 that is capable of supporting fixture 207. The fixture hoist 210 shown in FIG. 5 is shown in a docked state. FIG. 6, on the other hand, illustrates fixture hoist 210 in a deployed state, wherein cables 246′ and 246″ are extended. As shown in FIG. 6, base assembly 230 includes base 232, which may be a base plate, a bracket, or other foundation piece. Mounted to base 232 is a motor 240 having a shaft 245 rotatable in first and second directions. In this case, shaft 245 is a double-ended shaft wherein a portion of the shaft extends to one side of the motor and another portion extends to the opposite side. Attached to each end of shaft 245 is a drum (242′, 242″) with an associated cable (246′, 246″) disposed about, or wrapped around, the drum. Cables 246 extend downward and are attached to shuttle chassis 262, which is described below. Base 232 also supports an electrical connector 235 that contacts a corresponding connector 265, as explained more fully below. Electrical connector 235 includes an electric cable 238 which may connect to a power source associated with the ceiling or structure. Base assembly 230 also includes a pair of datum fittings 234′ and 234″. In this case, each datum fitting 234 is cone shaped, or funnel shaped, and includes a receptacle 236.

Shuttle assembly 260 includes a shuttle chassis 262 which supports a pair of datum fittings 264′ and 264″, in this case in the form of pins, which are configured to mate with conical datum fittings 234′ and 234″, respectively, when the shuttle assembly 260 is in the docked state. In this case, shuttle chassis 262 is dome-shaped and thereby acts as a covering for base assembly 230 when the shuttle assembly 260 is in the docked state. As mentioned above, shuttle assembly 260 includes an electrical connector 265 which is configured and located to mate with electrical contact interface 235 disposed on base 232. Accordingly, when shuttle assembly 260 is in the docked state, the two electrical connectors 235 and 265 are in electrical communication such that power provided from the house or structure may be transmitted via cable 268 to fixture 207 (See FIG. 5). The connectors may secure together by the upward force provided by the cables or by magnets disposed on the connectors. The magnets may be permanent magnets or may be in the form of an electro-magnet on one or both of the connectors.

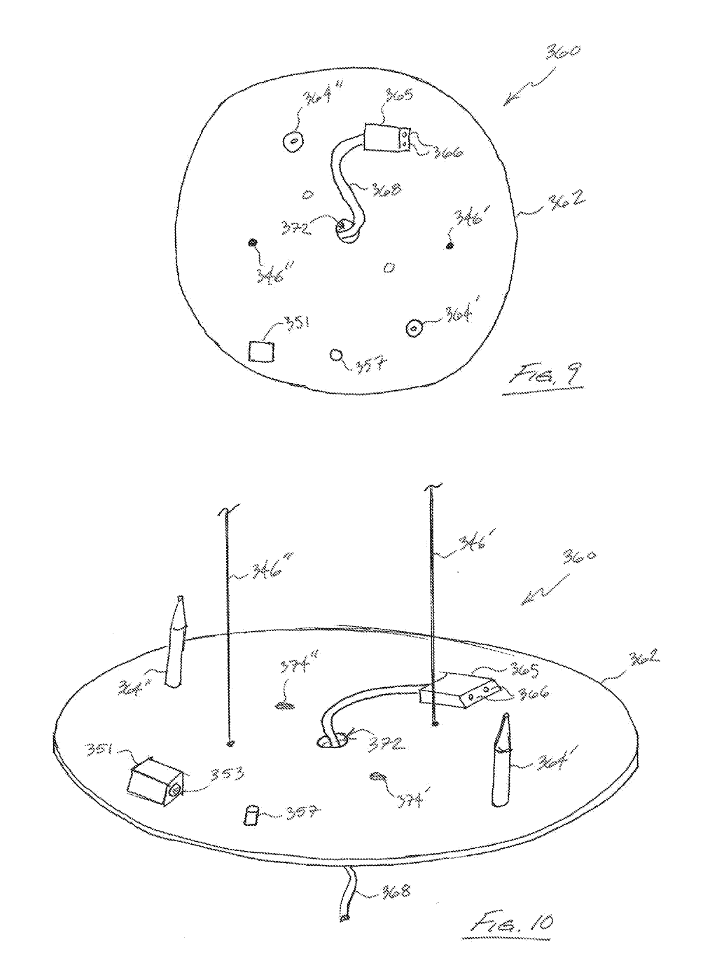

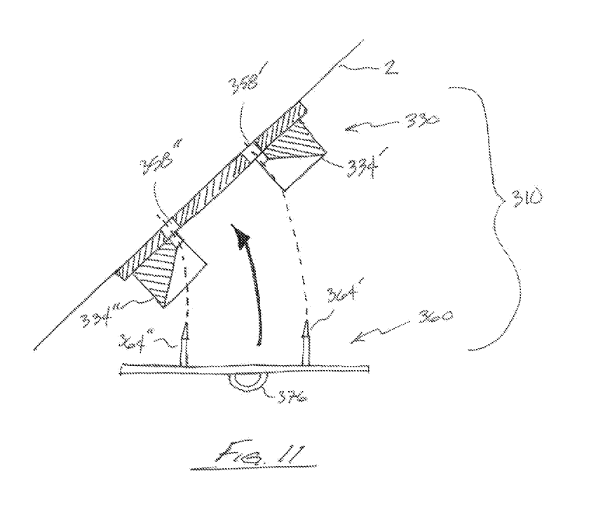

A ceiling fixture hoist according to a fourth exemplary embodiment is illustrated in FIGS. 7-11. Ceiling fixture hoist 310 (FIG. 11) is comprised of a base assembly 330 and a shuttle assembly 360. Base assembly 330 includes a base 332, in this case a base plate that supports the other components of the base assembly 330. A motor 340 is disposed on base 332 and includes a double-ended shaft 341 (not shown) which is connected to a pair of clutches 347′ and 347″. Motor 340 is supported on base 332 by a pair of mounting brackets 348. Extending from each clutch (347′, 347″) is a corresponding shaft (345′, 345″) which in turn is connected to a drum (342′, 342″). Each drum (342′, 342″) includes an associated cable (346′, 346″) disposed about the drum. With further reference to FIG. 8, it can be appreciated that cables 346 extend downwardly towards shuttle assembly 360 (See for example, FIGS. 9 and 10). Cables 346 may be comprised of, for example and without limitation, a single wire, multi-stranded wire, cord, monofilament line, and the like.

In this case, datum fittings 334 are in the form of a half socket. In particular, datum fittings (334′, 334″) are comprised of a section of a cylinder that has a frustoconical shaped receptacle 336. In this case, the datum fittings (334′, 334″) comprise approximately half of such a cylinder. However, the datum fitting may be a complete frustoconical, cylindrical piece. Datum fitting 334 provides a cone-shaped guide which leads mating pins (364′, 364″) into apertures 358′ and 358″.

Base 332 supports electrical connector 335 which is connected via cable 338 to a power source associated with the structure. As shown in FIG. 7, the electrical interface 335 includes a plurality of electrical contacts 349. Base plate 332 also supports a portion of locking mechanism 350, shown in FIG. 7, that includes a solenoid 352 with an associated lock pin 354. Locking mechanism 350 also includes a pin receiver 351 disposed on shuttle chassis 362 (FIG. 9). The locking mechanism 350 is operative to secure the shuttle assembly 360 to the base assembly 330 when the shuttle is in the docked state. Associated with lock mechanism 350 is a switch 356 which activates the lock mechanism 350 once shuttle assembly 360 approaches the docked state. An activation pin, or plunger, 357 is disposed on shuttle chassis 362 and is positioned and configured to operate switch 356 once shuttle chassis 360 is in the proper position. Once in the proper position, the lock pin 354 extends from solenoid 352 to engage aperture 353 formed in pin receiver 351.

Shuttle assembly 360 is shown in FIGS. 9 and 10 and includes a shuttle chassis 362 which supports the components of the shuttle assembly. As mentioned above, shuttle chassis 362 is attached to cables 346. Shuttle chassis 362 supports a pair of datum fittings (364′, 364″) in the form of pins. While the embodiments shown herein show the sockets on the base assembly and the mating pins on the shuttle assembly, the datum fittings may be reversed such that the pins are located on the base assembly and the sockets are located on the shuttle assembly.

Shuttle chassis 362 supports an electrical connector 365 which mates with electrical connector 335 disposed on base assembly 330. Electrical connector 365 also includes a plurality of contacts 366 which interface with the electrical contacts 349 on connector 335. Electrical connector 365 transmits electrical power to the fixture via electrical cable 368 which extends through aperture 372 formed through shuttle chassis 362. Shuttle chassis 362, as shown here, also includes a pair of mounting holes 374. In this case, mounting holes 374 are threaded for facilitating the attachment of a fixture. It is contemplated that mounting holes 374 may be the same size and spacing as a standard ceiling fixture box. Although shown here as mounting holes, other forms of mounting a fixture to shuttle assembly 360 may be used, such as mounting loop 376 shown in FIG. 11.

FIG. 11 is a schematic representation of ceiling fixture hoist 310 attached to an angled ceiling surface. In this case, ceiling 2 is angled at an approximately 45-degree angle. However, the socket and pin datum fixture arrangement (334, 364) disclosed herein allows for the shuttle assembly 360 to be guided into the apertures 358 such that the shuttle assembly is correctly located against the base assembly, thereby providing electrical contact and activation of locking mechanism, as well as a flush mount to the ceiling. Clutches 347 facilitate mounting the fixture hoist on an angled surface. Clutches 347 compensating for the necessary difference in cable lengths by allowing the two drums (342′, 342″) to slip relative to each other.

While various embodiments are shown here to include a fixture hoist as a separate assembly, the base assembly may be integrated into the ceiling, and similarly, the shuttle assembly may be integrated into a fixture. While the embodiments have been illustrated with components having relative sizes and positions, the size and position of various components may vary. For example, datum fittings 334 shown in FIGS. 7 and 8 may be larger or smaller. Moreover, the radial and circumferential positioning of the datums may vary as well.

The various embodiments shown herein include an electrical connector arrangement which disconnects power when the shuttle assembly is in the deployed state and connects power when the shuttle assembly is in the docked state. However, power may be continuously transmitted to the fixture via cables 346, for example, or by further including an extendable cord (for example, coiled) which extends between the shuttle assembly and the base assembly. Furthermore, the fixture hoists described herein may be activated by a wall-mounted switch or remote control.

Accordingly, the fixture hoist has been described with some degree of particularity directed to the exemplary embodiments. It should be appreciated, however, that the present invention is defined by the following claims construed in light of the prior art so that modifications or changes may be made to the exemplary embodiments without departing from the inventive concepts contained herein.

What is claimed is:

1. A fixture hoist, comprising:
A. a base assembly attachable to an overhead structure, including:
i. a base;
ii. a motor disposed on said base, said motor including a shaft rotatable in first and second directions;
iii. at least one drum coupled to said shaft;
iv. a cable disposed about said drum, whereby said cable is selectively extended or retracted by rotating said shaft in one of said first and second directions; and
v. at least one first datum fitting disposed on said base; and
B. a shuttle assembly capable of supporting a fixture, and movable between a docked state and a deployed state, said shuttle assembly including:
i. a shuttle chassis attached to said cable, whereby said shuttle assembly is deployed by extending said cable and docked by retracting said cable; and
ii. at least one second datum fitting configured to mate with said first datum fitting when said shuttle assembly is in the docked state.

2. A fixture hoist according to claim 1, comprising a pair of first datum fittings and a pair of second datum fittings.

3. A fixture hoist according to claim 1, wherein said at least one first datum fitting comprises a socket.

4. A fixture hoist according to claim 3, wherein said socket comprises a frustoconical receptacle.

5. A fixture hoist according to claim 3, wherein said socket comprises a portion of a frustoconical receptacle.

6. A fixture hoist according to claim 3, wherein said at least one second datum fitting comprises a pin.

7. A fixture hoist according to claim 1, comprising a pair of drums coupled to said shaft and a cable disposed about each said drum.

8. A fixture hoist according to claim 1, further comprising a locking mechanism operative to secure said shuttle assembly to said base assembly.

9. A fixture hoist according to claim 8, further comprising a switch operative to activate said locking mechanism when said shuttle assembly is in the docked state.

10. A fixture hoist according to claim 1, further comprising a plurality of cooperative electrical contacts disposed on said base and said shuttle chassis, said plurality of contacts operative to transmit electricity to a fixture supported by said shuttle assembly when in the docked state.

11. A fixture hoist according to claim 1, further comprising a clutch coupled between said shaft and said drum.

12. A ceiling fixture hoist, comprising:
A. a base assembly attachable to a ceiling, including:
i. a base;
ii. a motor disposed on said base, said motor including a double ended shaft rotatable in first and second directions;
iii. a clutch coupled to each end of said double ended shaft;
iv. a drum coupled to each said clutch;
v. a cable disposed about each said drum, whereby said cables are selectively extended or retracted by rotating said shaft in one of said first and second directions; and
vi. a pair of datum sockets disposed on said base; and
B. a shuttle assembly capable of supporting a ceiling fixture, and movable between a docked state and a deployed state, said shuttle assembly including:
i. a shuttle chassis attached to said cables, whereby said shuttle assembly is deployed by extending said cables and docked with said base assembly by retracting said cables; and
ii. a pair of datum pins configured to mate with said datum sockets when said shuttle assembly is in the docked state; and
C. a locking mechanism operative to secure said shuttle assembly to said base assembly.

13. A ceiling fixture hoist according to claim 12, further comprising a plurality of cooperative electrical contacts disposed on said base and said shuttle chassis, said plurality of contacts operative to transmit electricity to a ceiling fixture supported by said shuttle assembly when in the docked state.

14. A ceiling fixture hoist according to claim 12, wherein said datum sockets comprise a frustoconical receptacle.

15. A ceiling fixture hoist according to claim 12, wherein said datum sockets comprise a portion of a frustoconical receptacle.

16. A retractable ceiling fixture, comprising:
A. a base assembly attachable to a ceiling, including:
i. a base;
ii. a motor disposed on said base, said motor including a shaft rotatable in first and second directions;
iii. at least one clutch coupled to said shaft;
iv. at least one drum coupled to said at least one clutch;
v. a cable disposed about said at least one drum, whereby said cable is selectively extended or retracted by rotating said shaft in one of said first and second directions; and
vi. at least one first datum fitting disposed on said base; and
B. a ceiling fixture assembly movable between a docked state and a deployed state, said ceiling fixture assembly including:
i. a ceiling fixture attached to said cable, whereby said ceiling fixture assembly is deployed by extending said cable and docked with said base assembly by retracting said cable; and
ii. at least one second datum fitting configured to mate with said first datum fitting when said ceiling fixture assembly is in the docked state.

17. A retractable ceiling fixture according to claim 16, further comprising a locking mechanism operative to secure said ceiling fixture assembly to said base assembly.

18. A retractable ceiling fixture according to claim 16, further comprising a plurality of cooperative electrical contacts disposed on said base and said ceiling fixture, said plurality of contacts operative to transmit electricity to said ceiling fixture when said ceiling fixture assembly is in the docked state.

19. A retractable ceiling fixture according to claim 16, comprising a pair of first datum fittings and a pair of second datum fittings.

20. A retractable ceiling fixture according to claim 19, wherein said first datum fittings are sockets and said second datum fittings are pins.
